(19) United States
(12) Patent Application Publication
(10) Pub. No.: US 2011/0090161 A1
(43) Pub. Date: Apr. 21, 2011

(54) INFORMATION INPUT DEVICE, INFORMATION INPUT METHOD, INFORMATION INPUT/OUTPUT DEVICE, INFORMATION PROGRAM AND ELECTRONIC DEVICE

(75) Inventors: Ryoichi Tsuzaki, Aichi (JP); Kazunori Yamaguchi, Kanagawa (JP)

(73) Assignee: Sony Corporation, Tokyo (JP)

(21) Appl. No.: 12/899,008

(22) Filed: Oct. 6, 2010

(30) Foreign Application Priority Data
Oct. 16, 2009 (JP) 2009-239512

(51) Int. Cl. G06F 3/041

(52) U.S. Cl. 345/173

(57) ABSTRACT

An information input device includes an input panel including detection elements each obtaining a detection signal from an object, an image processing section performing predetermined image processing on the detection signal obtained by the input panel, thereby obtaining touch point information which is indicative of whether the object is in a touch state and proximity point information which is indicative of whether the object is in a proximity state. The information input device further includes a drive section driving each of the detection elements in the input panel in such a manner that the detection signal is obtained from each of the detection elements at predetermined drive intervals, and a control section determining the drive interval based on the touch point information and the proximity point information obtained by the image processing section.

### BACKGROUND OF THE INVENTION

1. Field of the Invention

The present invention relates to an information input device, an information input method, an information input program, an information input/output device and an electronic device which input information by contact or proximity of an object.

2. Description of the Related Art

In recent years, the development of a display with a touch sensor allowed to input information by direct contact of a finger or the like with a display screen of the display has been proceeding. Types of the touch sensor include an optical type which optically detects a finger or the like, and so on in addition to a contact type which detects a position of a touched electrode, a capacitive type using a change in capacitance. For example, in the optical type touch sensor, an object in proximity to a display screen is irradiated with image display light or the like, and the presence or absence of an object or the position or the like of the object is detected based on light reflected from the object as described in, for example, Japanese Unexamined Patent Application Publication No. 2008-146165.

In such an optical type touch sensor, specifically a reduction in power consumption is an important issue. As one solution to solve the issue, a technique of changing the operation state of a software image processing section (an MPU), which executes predetermined image processing, according to whether an object comes in contact with the display screen is proposed, for example, as described in Japanese Unexamined Patent Application Publication No. 2008-262548. Typically, to detect a contact point, it is necessary to execute advanced image processing such as labeling in the MPU, but such an image processing operation has a heavy load, and power is consumed in the image processing operation. Therefore, in Japanese Unexamined Patent Application Publication No. 2008-262548, the MPU is controlled to be in a process execution state only in the case where an object is in contact with the display screen and to switch from the process execution state to a sleep state in the case where an object is not in contact with the display screen. Then, switching between a mode where a photodetector is fully driven and a mode where the photodetector is intermittently driven is performed in response to such state switching of the MPU.

### SUMMARY OF THE INVENTION

However, in the technique using an intermittent drive as in the case of Japanese Unexamined Patent Application Publication No. 2008-262548, in a state where an object is not in contact with an input screen (in a state where information is not input), a drive interval is set to be low (for example, a few frames per second), so it is difficult to detect contact of the object. Moreover, when the object moves away from the input screen (in the case where the object is not in contact with the input screen but in proximity to the input screen), it is difficult to detect the object. Therefore, in particular, it is difficult to recognize an input operation with predetermined movement such as a flick (movement of quickly sliding a finger across the input screen) or a double click, and as a result, operability as a touch sensor is deteriorated. Therefore, it is desired to achieve a touch sensor (an information input device) maintaining good operability while reducing power consumption.

It is desirable to provide an information input device, an information input method, an information input/output device, an information input program and an electronic device which are allowed to maintain good operability while reducing power consumption.

According to an embodiment of the invention, there is provided an information input device including: an input panel including a detection element for obtaining a detection signal from an object; an image processing section performing predetermined image processing on the detection signal obtained by the input panel to obtain touch point information which is indicative of whether the object is in a contact state and proximity point information which is indicative of whether the object is in a proximity state; a drive section driving the detection element in the input panel to obtain the detection signal at predetermined drive intervals; and a control section determining the drive interval based on the touch point information and the proximity point information obtained by the image processing section. Note that in the invention, “contact” means only the case where an object is literally in contact with an input screen, and “proximity” means not only the case where an object is in contact with the input screen but also the case where an object is not in contact with the input screen and is present in a space from the input screen to a predetermined height.

According to an embodiment of the invention, there is provided an information input method including the steps of: obtaining a detection signal of an object by an input panel including a detection element; performing predetermined image processing on the obtained detection signal to obtain touch point information which is indicative of whether the object is in a contact state and proximity point information which is indicative of whether the object is in a proximity state; driving the detection element in the input panel to obtain the detection signal at predetermined drive intervals; and determining the drive interval based on the touch point information and the proximity point information.

According to an embodiment of the invention, there is provided an information input/output device including: an input/output panel including a detection element for obtaining a detection signal from an object and having an image display function; an image processing section performing predetermined image processing on the detection signal obtained by the input/output panel to obtain touch point information which is indicative of whether the object is in a contact state and proximity point information which is indicative of whether the object is in a proximity state; a drive section driving the detection element in the input/output panel to obtain the detection signal at predetermined drive intervals; and a control section determining the drive interval based on the touch point information and the proximity point information obtained by the image processing section.

According to an embodiment of the invention, there is provided an information input program causing a computer to execute the steps of: obtaining a detection signal of an object by an input panel including a detection element; performing predetermined image processing on the obtained detection signal to obtain touch point information which is indicative of whether the object is in a contact state and proximity point information which is indicative of whether the object is in a proximity state; driving the detection element in the input panel to obtain the detection signal at predetermined drive intervals; and determining the drive interval based on the touch point information and the proximity point information.

According to an embodiment of the invention, there is provided an electronic device including the above-described information input device according to the embodiment of the invention.

In the information input device, the information input method, the information input/output device, the information input program and the electronic device according to the embodiment of the invention, predetermined image processing is performed on a detection signal of an object obtained by an input panel to obtain touch point information which is indicative of whether the object is in a contact state and proximity point information which is indicative of whether the object is in a proximity state. The drive interval of the detection element in the input panel is determined based on the touch point information and the proximity point information.

In the information input device, the information input method, the information input/output device, the information input program and the electronic device according to the embodiment of the invention, predetermined image processing is performed on a detection signal of an object obtained by an input panel to obtain touch point information which is indicative of whether the object is in a contact state and proximity point information which is indicative of whether the object is in a proximity state, and the drive interval in the input panel is determined based on the touch point information and the proximity point information, so deterioration of operability is preventable while performing an intermittent detection drive. Therefore, good operability is allowed to be maintained while reducing power consumption.

Other and further objects, features and advantages of the invention will appear more fully from the following description.

### BRIEF DESCRIPTION OF THE DRAWINGS

FIG. 1 is a block diagram illustrating a configuration of an information input/output device according to an embodiment of the invention.

FIG. 2 is a block diagram illustrating a specific configuration of an input/output panel illustrated in FIG. 1.

FIG. 3 is an enlarged sectional view of a part of the input/output panel illustrated in FIG. 1.

FIG. 4 is a chart illustrating an example of switching from one object detection mode to another.

FIGS. 5A, 5B and 5C are schematic views for describing states of an object (a finger) in a detection standby mode, a contact point detection mode and a proximity point detection mode, respectively.

FIG. 6 is a flow chart illustrating an example of image processing (a point information detection process).

FIGS. 7A and 7B are schematic views for describing timings of switching from the detection standby mode to the proximity point detection mode and the contact point detection mode.

FIGS. 8A and 8B are schematic views for describing timings of switching from the proximity point detection mode to the contact point detection mode and the detection standby mode.

FIGS. 9A and 9B are schematic views for describing timings of switching from the contact point detection mode to the proximity point detection mode and the detection standby mode.

FIG. 10 is an illustration for describing an intermittent drive operation according to a comparative example.

FIG. 11 is an illustration of switching from one object detection mode to another according to Modification 1.

FIGS. 12A and 12B are schematic views for describing a delay operation in the proximity point detection mode illustrated in FIG. 11.

FIGS. 13A and 13B are schematic views for describing a delay operation in the contact point detection mode illustrated in FIG. 11.

FIGS. 14A and 14B are schematic views for describing a delay operation in the contact point detection mode illustrated in FIG. 11.

FIG. 15 is a block diagram illustrating a configuration of an information input/output device according to Modification 2.

FIG. 16 is an external perspective view of Application Example 1 of the information input/output device according to the embodiment or the like of the invention.

FIGS. 17A and 17B are an external perspective view from the front side of Application Example 2 and an external perspective view from the back side of Application Example 2, respectively.

FIG. 18 is an external perspective view of Application Example 3.

FIG. 19 is an external perspective view of Application Example 4.

FIGS. 20A to 20G illustrate Application Example 5, FIGs. Where 20A and 20B are a front view and a side view in a state in which Application Example 5 is opened, respectively, and FIGS. 20C, 20D, 20E, 20F and 20G are a front view, a left side view, a right side view, a top view and a bottom view in a state in which Application Example 5 is closed, respectively.

### DETAILED DESCRIPTION OF THE PREFERRED EMBODIMENTS

A preferred embodiment will be described in detail below referring to the accompanying drawings. Descriptions will be given in the following order.

1. Embodiment (Example of information input process in which a drive interval is changed based on touch point information and proximity point information of an object)
2. Modification 1 (Example in which a timing of changing to a lower drive interval is delayed)
3. Modification 2 (Another example of information input device)
4. Application Examples 1 to 5 (Application examples to electronic devices)

### Embodiment

### Whole Configuration of Information Input/Output Device 1

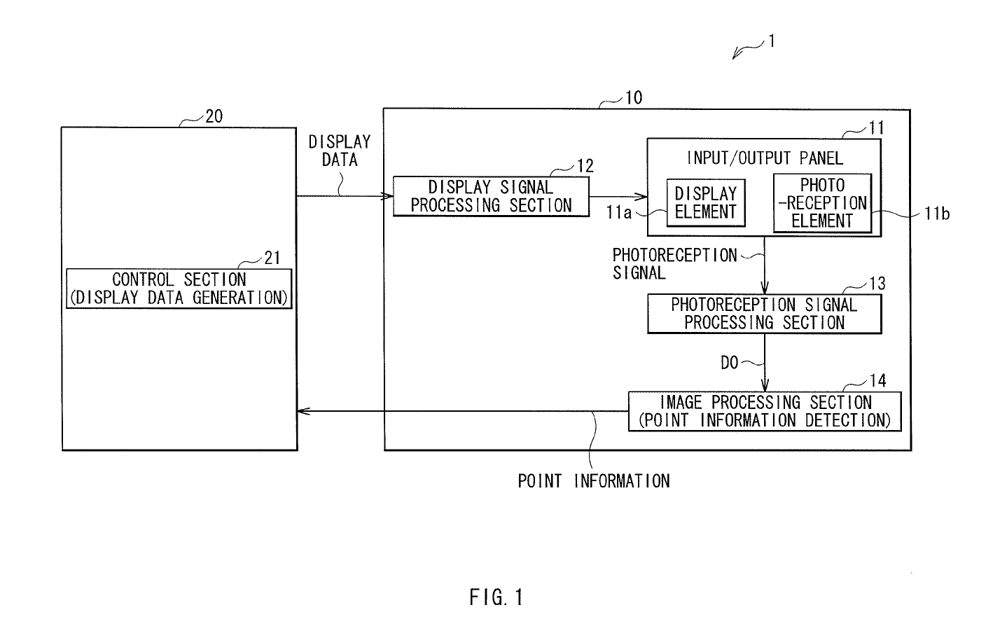

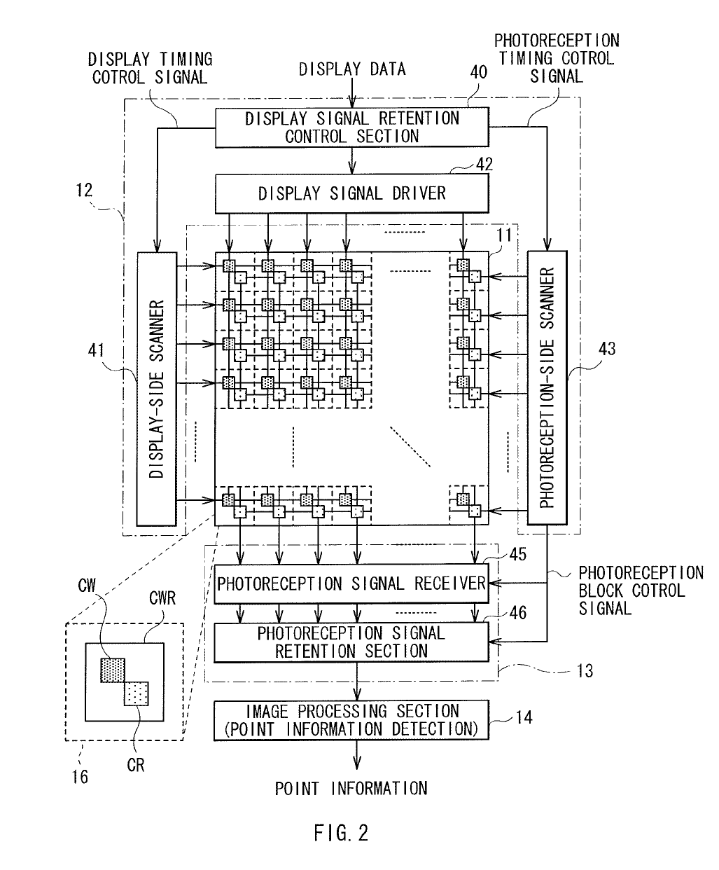

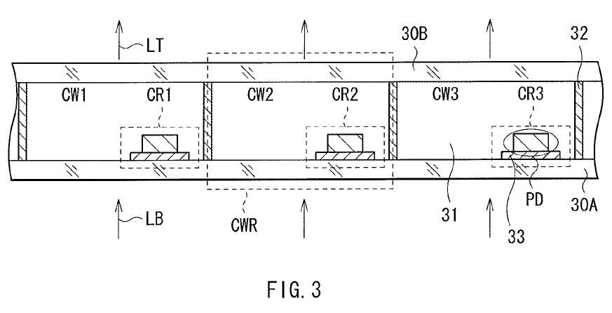

FIG. 1 illustrates a schematic configuration of an information input/output device (an information input/output device 1) according to an embodiment of the invention. FIG. 2 illustrates a specific configuration of a display 10, and FIG. 3 illustrates an enlarged sectional view of a part of an input/output panel 11. The information input/output device 1 is a display having a function of inputting information with use of a finger, a stylus or the like, that is, a touch sensor function. The information input/output device 1 includes the display 10 and an electronic device body 20 using the display 10. The display 10 includes the input/output panel 11, a display signal processing section 12, a photodetection signal processing section 13 and an image processing section 14, and the electronic device body 20 includes a control section 21. An information input method and an information input program according to an embodiment of the invention are embodied in the information input/output device 1 according to the embodiment, and will not be described.

Input/Output Panel 11

For example, as illustrated in FIG. 2, the input/output panel 11 is a liquid crystal display panel in which a plurality of pixels 16 are arranged in a matrix form, and each of the pixels 16 includes a display element 11a (a display cell CW) and a photodetector 11b (a photodetection cell CR). The display element 11a is a liquid crystal element for displaying an image with use of light emitted from a backlight (not illustrated). The photodetector 11b is, for example, a photodetector, such as a photodiode, outputting an electrical signal in response to reception of light. In this case, the photodetector 11b receives light reflected back from an object in contact with or in proximity to a panel to the inside of the panel, and outputs a photodetection signal (a detection signal). In each of the pixels 16, one photodetection cell CR may be arranged so as to be allocated to one display cell CW or a plurality of display cells CW.

The input/output panel 11 includes, for example, a plurality of following display/photodetection cells CWR as a plurality of pixels 16. More specifically, as illustrated in FIG. 3, the plurality of display/photodetection cells CWR are configured by including a liquid crystal layer 31 between a pair of transparent substrates 30A and 30B, and the plurality of display/photodetection cells CWR are separated from one another by barrier ribs 32. A photodetector PD is arranged in a part of each display/photodetection cell CWR, and a region corresponding to the photodetector PD of each display/photodetection cell CWR is a photodetection cell CR (CR1, CR2, CR3, . . . ), and the other region of each display/photodetection cell CWR is a display cell CW (CW1, CW2, CW3, . . . ). In the photodetection cell CR, to prevent entry of light LB emitted from the backlight, a light-shielding layer 33 is arranged between the transparent substrate 30A and the photodetector PD. Therefore, in each photodetector PD, only light entering from the transparent substrate 30B (reflected light from an object) is detected without influence of backlight light LB. Such an input/output panel 11 is connected to a display signal processing section 12 arranged preceding thereto and a photodetection signal processing section 13 arranged subsequent thereto.

Display Signal Processing Section 12

The display signal processing section 12 is a circuit driving the input/output panel 11 to perform an image display operation and a photodetection operation based on display data, and includes, for example, a display signal retention control section 40, a display-side scanner 41, a display signal driver 42 and a photodetection-side scanner 43 (refer to FIG. 2). The display signal retention control section 40 stores and retains a display signal output from a display signal generation section 44 in, for example, a field memory such as an SRAM (Static Random Access Memory), and controls operations of the display-side scanner 41, the display signal driver 42 and the photodetection-side scanner 43. More specifically, the display signal retention control section 40 outputs a display timing control signal and a photodetection timing control signal to the display-side scanner 41 and the photodetection-side scanner 43, respectively, and outputs, to the display signal driver 42, display signals for one horizontal line based on the display signal retained in the field memory. Therefore, in the input/output panel 11, a line-sequential display operation and a photodetection operation are performed.

The display-side scanner 41 has a function of selecting a display cell CW to be driven in response to the display timing control signal output from the display signal retention control section 40. More specifically, a display selection signal is supplied through a display gate line connected to each pixel 16 of the input/output panel 11 to control a display element selection switch. In other words, when a voltage allowing the display element selection switch of a given pixel 16 to turn on is applied in response to the display selection signal, the given pixel 16 performs a display operation with luminance corresponding to the voltage supplied from the display signal driver 42.

The display signal driver 42 has a function of supplying display data to the display cell CW to be driven in response to the display signals for one horizontal line output from the display signal retention control section 40. More specifically, a voltage corresponding to display data is supplied to the pixel 16 selected by the above-described display-side scanner 41 through a data supply line connected to each pixel 16 of the input/output panel 11.

The photodetection-side scanner 43 has a function of selecting a photodetection cell CR to be driven in response to a photodetection timing control signal output from the display signal retention control section 40. More specifically, a photodetection selection signal is supplied through a photodetection gate line connected to each pixel 16 of the input/output panel 11 to control a photodetection device selection switch. In other words, as in the case of the operation of the above-described display-side scanner 41, when a voltage allowing the photodetection device selection switch of a given pixel 16 to turn on is applied in response to the photodetection selection signal, a photodetection signal detected from the given pixel 16 is output to a photodetection signal receiver 45. Therefore, for example, light emitted from a given display cell CW as display light is reflected by an object, and the reflected light is allowed to be received and detected in the photodetection cell CR. Such a photodetection-side scanner 43 also has a function of supplying a photodetection block control signal to the photodetection signal receiver 45 and a photodetection signal retention section 46 to control a block contributing to a photodetection operation. In the embodiment, the above-described display gate line and the above-described photodetection gate line are separately connected to each display/photodetection cell CWR, so the display-side scanner 41 and the photodetection-side scanner 43 are operable independently of each other.

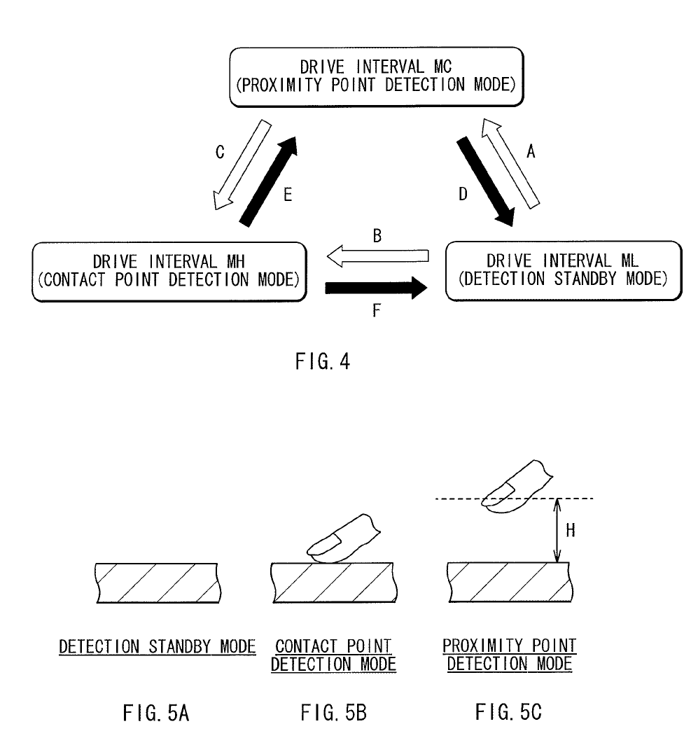

In the embodiment, each photodetection cell CR is driven at predetermined drive intervals (fps: frame/sec) so that the photodetection-side scanner 43 performs a photodetection drive at intermittent timings along time axis according to control of the control section 21. In addition, preferably, the backlight is driven to intermittently turn on in synchronization with photodetection drive intervals. Then, the control section 21 which will be described later determines (more specifically, changes or maintains) the drive interval according to the presence or absence of an object in contact with an input screen and the presence or absence of an object in proximity to the input screen. Moreover, according to such a drive interval, a plurality of object detection modes (in this case, three object detection modes, that is, a detection standby mode, a proximity point detection mode and a contact point detection mode) appear. These object detection modes are allowed to be switched from one to another by changing the above-described drive interval (refer to A to F in FIG. 4). In other words, in the embodiment, as will be described in detail later, the object detection modes are switched from one to another by dynamically changing the drive interval in conjunction with a change in the state of an object (a change between a contact state, a proximity state and a state which is neither the contact state nor the proximity state).

More specifically, the detection standby mode is a mode appearing in a state where an object is neither in contact with nor in proximity to an input screen (a panel surface) (information is not input) (refer to FIG. 5A), and a lowest drive interval ML is used. The contact point detection mode is a mode appearing in a state where an object (more specifically, a part of a surface of an object such as the ball of a finger) is in contact with the input screen (refer to FIG. 5B), and a longest drive interval MH is used. The proximity point detection mode is a mode appearing in a state where an object is placed in a space from the input screen to a predetermined height (distance) H (refer to FIG. 5C), and an intermediate drive interval MC between the drive intervals ML and MH is used. However, a length comparison relationship between the drive intervals ML, MC and MH is ML≦MC≦MH. In addition, in the description, “contact” means only the case where an object is literally in contact with the input screen, and “proximity” means not only the case where an object is in contact with the input screen but also the case where an object is not in contact with the input screen and is placed in a space from the input screen to a predetermined height.

Photodetection Signal Processing Section 13

The photodetection signal processing section 13 captures the photodetection signal from the photodetector 11b and performs signal amplification, a filter process, or the like, and includes, for example, the photodetection signal receiver 45 and the photodetection signal retention section 46 (refer to FIG. 2).

The photodetection signal receiver 45 has a function of obtaining photodetection signals for one horizontal line output from each photodetection cell CR in response to the photodetection block control signal output from the photodetection-side scanner 43. The photodetection signals for one horizontal line obtained in the photodetection signal receiver 45 are output to the photodetection signal retention section 46.

The photodetection signal retention section 46 stores and retains the photodetection signals output from the photodetection signal receiver 45 in, for example, a field memory such as an SRAM in response to the photodetection block control signal output from the photodetection-side scanner 43. Data of the photodetection signals stored in the photodetection signal retention section 46 is output to the image processing section 14. The photodetection signal retention section 46 may be configured of a storage element except for a memory, and, for example, the photodetector signals may be retained as analog data (an electric charge) in a capacitive element.

Image Processing Section 14

The image processing section 14 follows and is connected to the photodetection signal processing section 13, and is a circuit capturing picked-up image data from the photodetection signal processing section 13 to perform predetermined image processing, thereby detecting information of an object (point information). More specifically, the image processing section 14 performs a process such as binarization, isolated point removal or labeling to obtain information of a contact object (touch point information), information of a proximity object (proximity point information) or the like. The touch point information includes information about the presence or absence of an object in contact with the input screen, information about the position or area of the contact object, and the like. Likewise, the proximity point information includes information about the presence or absence of an object in proximity to the input screen, information about the position or area of the proximity object, and the like.

Electronic Device Body 20

The electronic device body 20 outputs display data to the display signal processing section 12 of the display 10, and the above-described point information (touch point information and proximity point information) from the image processing section 14 is input into the electronic device body 20. The electronic device body 20 includes the control section 21 configured of, for example, a CPU (Central Processing Unit). The control section 21 generates display data or changes a display image based on the point information. Moreover, the control section 21 performs control to determine a drive interval in the input/output panel 11 based on the input point information.

Functions and Effects of Information Input/Output Device 1

### 1. Image Display Operation, Photodetection Operation

When the display data output from the electronic device body 20 is input into the display signal processing section 12, the display signal processing section 12 drives the input/output panel 11 to perform display and receive light based on the display data. Therefore, in the input/output panel 11, an image is displayed by the display elements 11a (the display cells CW) with use of emitted light from the backlight (not illustrated). On the other hand, in the input/output panel 11, the photodetectors 11b (the photodetection cells CR) are driven at predetermined drive intervals to receive light.

In such a state that the image display operation and the photodetection operation are performed, when an object such as a finger comes in contact with or in proximity to a display screen (an input screen) of the input/output panel 11, a part of light emitted for image display from each of the display elements 11a is reflected by a surface of the object. The reflected light is captured in the input/output panel 11 to be received by the photodetector 11b. Therefore, a photodetection signal of the object is output from the photodetector 11b. The photodetection signal processing section 13 performs a process such as amplification on the photodetection signal to process the photodetection signal, thereby generating a picked-up image. The generated picked-up image is output to the image processing section 14 as picked-up image data D0.

### 2. Point Information Detection Process

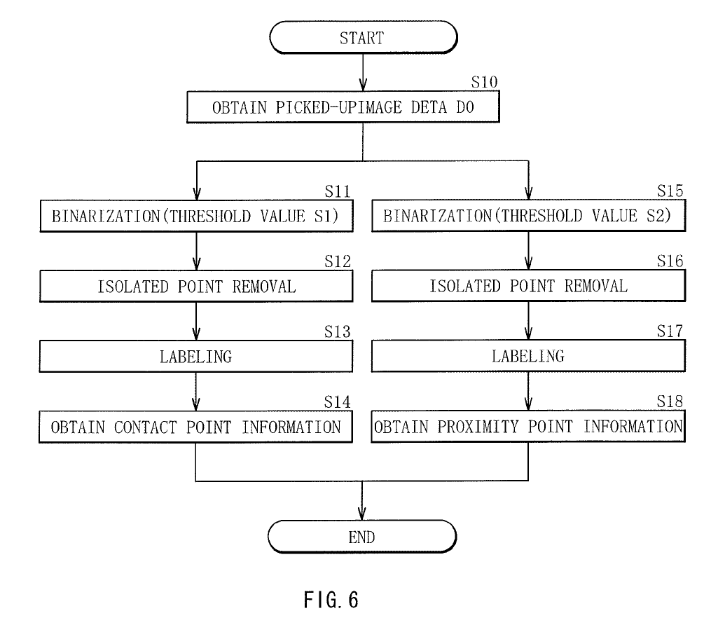

FIG. 6 illustrates a flow of whole image processing (a point information detection process) in the image processing section 14. The image processing section 14 obtains the picked-up image data D0 from the photodetection signal processing section 13 (step S10), and obtains the touch point information and the proximity point information through a binarization process with use of two different threshold values on the picked-up image data D0. More specifically, the image processing section 14 stores two preset threshold values S1 and S2 (S1>S2), and the following image processing with use of the threshold values S1 and S2 is performed to obtain the touch point information and the proximity point information, respectively.

Obtaining Touch Point Information: S11 to S14

The image processing section 14 performs a binarization process with use of the threshold value S1 (a first threshold value) on the obtained picked-up image data D0 (step S11). More specifically, the signal value of each of pixels configuring the picked-up image data D0 is compared with the threshold value S1, and, for example, when a part has a signal value lower than the threshold value S1, the part is set to “0”, and when a part has a signal value equal to or higher than the threshold value S1, the part is set to “1”. Therefore, when a contact object is present, a part receiving light reflected by the object is set to“1”, and the other part is set to “0”.

Next, the image processing section 14 removes an isolated point (noise) from the above-described binarized picked-up image (step S12). In other words, in the binarized picked-up image in the case where the contact object is present, an aggregate region of parts set to “1” is formed, but in the case where a part set to “1” is isolated from the aggregate region of parts set to “1”, a process of removing the isolated part is performed.

Thereafter, the image processing section 14 performs a labeling process on the picked-up image subjected to isolated point removal (step S13). In other words, a labeling process is performed on the aggregate region of parts set to “1” in the picked-up image, and the aggregate region of parts set to “1” subjected to the labeling process is used as a detection point (a detection region) of the contact object. In the case where such a detection point is present, it is determined that an object in contact with the input screen is “present” and in the case where the detection point is absent, it is determined that an object in contact with the input screen is “absent”. Moreover, in the case where the detection point is present, position coordinates, area and the like of the detection point are calculated. Therefore, touch point information including information about the presence or absence of an object in contact with the input screen or the position of the object in contact with the input screen is obtained (step S14).

Obtaining Proximity Point Information: S15 to S18

The image processing section 14 performs a binarization process with use of the threshold value S2 (a second threshold value) on the obtained picked-up image data D0 (step S15). More specifically, in the same manner as in the case where the above-described touch point information is obtained, the signal value of each of pixels configuring the picked-up image data D0 is compared to the threshold value S2, and a part having a signal value equal to or higher than S2 is set to “1”, and the other part is set to “0”. Next, as in the case of the above-described step S12, an isolated point is removed from the binarized picked-up image (step S16). Thereafter, as in the case of the above-described step S13, a labeling process is performed on the picked-up image subjected to isolated point removal (step S17). Then, in the case where a detection point is present in the picked-up image subjected to the labeling process, it is determined that an object in proximity to the input screen is “present”, and position coordinates and the like of the object in proximity to the input screen are calculated. In the case where the detection point is absent, it is determined that an object in proximity to the input screen is “absent”. Therefore, proximity point information including information about the presence or absence of an object in proximity to the input screen or information about the position or the like of the object in proximity to the input screen is obtained (step S18).

In addition, these steps of obtaining the touch point information (S11 to S14) and these steps of obtaining the proximity point information (S15 to S18) may be executed concurrently or sequentially (for example, after execution of the steps S11 to S14, the steps S15 to S18 may be executed). Moreover, in the case where position information or area information of an object is not necessary as point information, that is, in the case where it is sufficient to detect only information about the presence or absence of an object in contact with or in proximity to the input screen, complicated image processing such as the above-described binarization, isolated point removal and labeling may not be executed. In this case, when the presence or absence of the object in contact with the input screen is detected, for example, the signal value of each of the pixels configuring the picked-up image data D0 is compared to the threshold value S1, and the number of pixels having a signal value equal to or higher than the threshold value S1 is counted, and a ratio of the number of pixels having a signal value equal to or higher than the threshold value S1 to the total number of pixels is determined. In the case where the ratio is equal to or higher than a predetermined value, it may be determined that an object in contact with the input screen is “present”, and in the case where the ratio is lower than the value, it may be determined that an object in contact with the input screen is “absent” Likewise, in the case of the object in proximity to the input screen, the above-described ratio may be determined with use of the threshold value S2 to determine the presence or absence of the object in proximity to the input screen.

By the above-described process, in the case where an object is in a contact state, the image processing section 14 obtains the detection point of a contact object by the steps S11 to S14 to obtain touch point information including a determination result that “a contact object is present” and the position or the like of the contact object. On the other hand, in the case where an object is in a proximity state, the detection point of a contact object is not obtained in the steps S11 to S14 (touch point information including a determination result that “a contact object is absent” is obtained), but the detection point of a proximity object is obtained by the steps S15 to S18 to obtain proximity point information including a determination result that “a proximity object is present” and information about the position or the like of the proximity object. Further, in the case where an object is neither in the contact state nor in the proximity state, the detection point is not obtained by both of the steps S11 to S14 and the steps S15 to S18. In this case, touch point information including a determination result that “a contact object is absent” and proximity point information including a determination result that “a proximity object is absent” are obtained. The point information such as the touch point information and the proximity point information obtained in such a manner is output to the electronic device body 20.

In the electronic device body 20, the control section 21 generates display data based on the input point information, and performs a display drive of the input/output panel 11 so as to change an image presently displayed on the input/output panel 11. Moreover, the control section 21 changes the drive interval based on the point information to control switching of the object detection modes. A drive interval changing operation based on such point information will be described in detail below.

### 3. Drive Interval Changing Operation

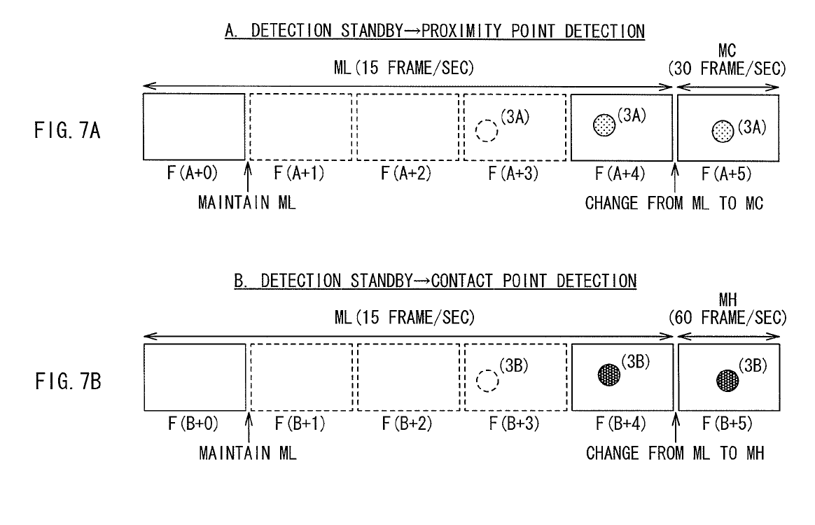

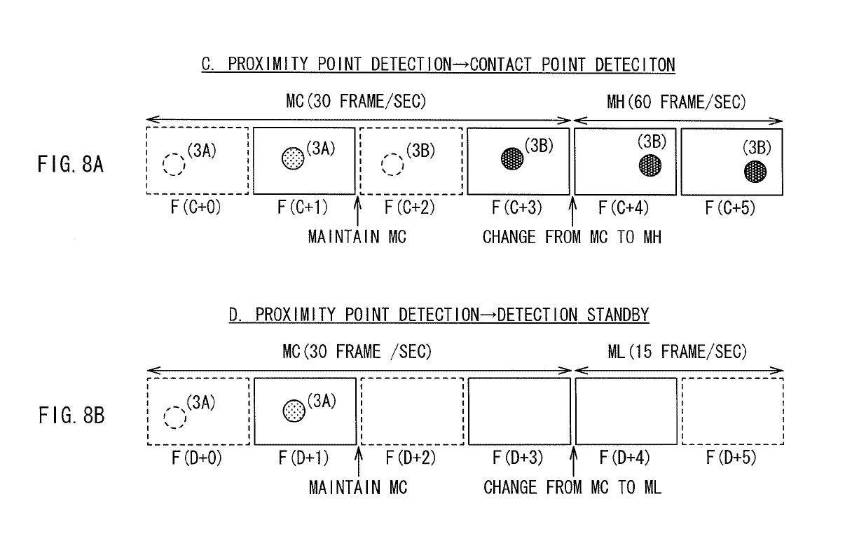

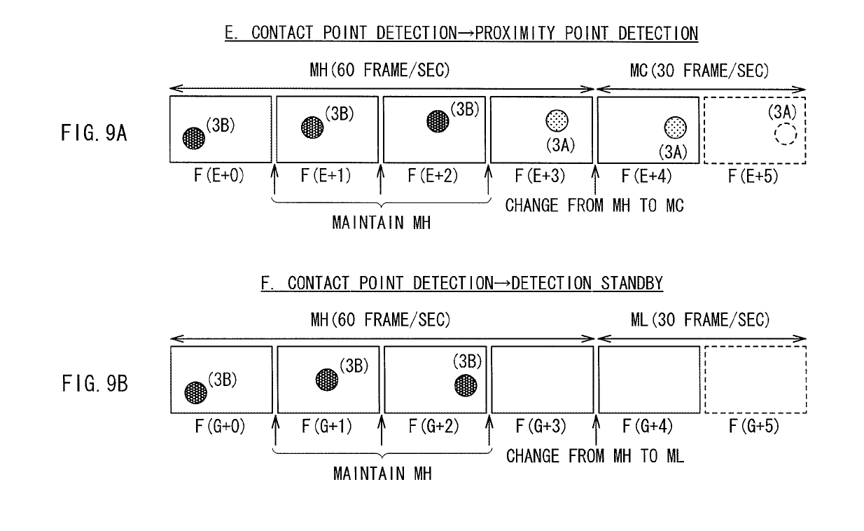

FIGS. 7A and 7B to FIGS. 9A and 9B are schematic views for describing a timing of changing the drive interval (a timing of switching of the object detection modes). FIGS. 7A and 7B illustrate switching from the detection standby mode to the proximity point detection mode and the contact point detection mode, respectively. FIGS. 8A and 8B illustrate switching from the proximity point detection mode to the contact point detection mode and the detection standby mode, respectively. FIGS. 9A and 9B illustrate switching from the contact point detection mode to the proximity point detection mode and the detection standby mode, respectively. In addition, frames (F) in each drawing correspond to frames in the case where a photodetection drive is performed at 60 fps. Moreover, a frame drawn by a solid line in these frames corresponds to a picked-up image obtained by an actual photodetection drive operation, and a frame drawn by a broken line corresponds to a picked-up image which is not actually obtained. Moreover, in the frames, a proximity object (3A) is schematically represented by a lightly stippled circle and a contact object (3B) is schematically represented by a heavily stippled circle.

The drive interval ML in the detection standby mode is the lowest drive interval between the three object detection modes, and in the case where 60 fps is a full drive interval, for example, the detection standby mode has a drive interval equal to approximately 1/20 to ¼ of the full drive interval. The drive interval MH in the contact point detection mode is the longest drive interval between the three object detection modes, and the contact point detection mode has, for example, a drive interval of 60 fps. The drive interval MC in the proximity point detection mode is set to an intermediate value between the drive interval ML and the drive interval MH. Herein, the case where, for example, a drive interval (15 fps) equal to ¼ of the full drive interval, a drive interval (30 fps) equal to ½ of the full drive interval and a drive interval of 60 fps are used as the drive intervals ML, MC and MH, respectively, will be described below.

A. Switching from Detection Standby Mode to Proximity Point Detection Mode

As illustrated in FIG. 7A, in the detection standby mode, first, the above-described image processing (the point information detection process) is performed based on a picked-up image at a timing of a frame F (A+0). At this timing, point information including a determination result that an object in contact with the input screen and an object in proximity to the input screen are absent is obtained, and the control section 21 maintains the drive interval ML based on such point information (from the frame F(A+0) to a frame F(A+4)). Next, for example, in the case where a proximity object is present from a timing of a frame F(A+3), a detection point 3A of the proximity object is obtained at the next detection frame F(A+4). More specifically, point information including a determination result that a proximity object is present (and a contact object is absent) is obtained, and the control section 21 changes from the drive interval ML to the drive interval MC based on such point information. Therefore, switching from the detection standby mode to the proximity point detection mode is performed.

B. Switching from Detection Standby Mode to Contact Point Detection Mode

As illustrated in FIG. 7B, in the detection standby mode, first, at a timing of a frame F(B+0), an object in contact with the input screen and an object in proximity to the input screen are absent. Therefore, as in the case of the above-described frames F(A+0) to F(A+4), the control section 21 maintains the drive interval ML (from the frame F(B+0) to a frame F(B+4)). Next, for example, in the case where a contact object is present from a timing of a frame F(B+3), at the next detection frame F(B+4), a detection point 3B of the contact object is obtained. More specifically, point information including a determination result that a contact object is present is obtained, and the control section 21 changes from the drive interval ML to the drive interval MH based on such point information. Therefore, switching from the detection standby mode to the contact point detection mode is performed.

Thus, in the detection standby mode, when it is determined that a contact object and a proximity object are absent, the control section 21 still maintains the drive interval ML. On the other hand, when it is determined that a proximity object is present (and a contact object is absent), the control section 21 performs control to change from the drive interval ML to the drive interval MC, and when it is determined that a contact object is present, the control section 21 performs control to change from the drive interval ML to the drive interval MH.

C. Switching from Proximity Point Detection Mode to Contact Point Detection Mode

As illustrated in FIG. 8A, in the proximity point detection mode, the above-described image processing (the point information detection process) is performed based on a picked-up image at a timing of a frame F(C+1). At this timing, a detection point 3A of a proximity object is obtained, and point information including a determination result that a proximity object is present is obtained. The control section 21 maintains the drive interval MC based on such point information (from the frame F(C+1) to a frame F(C+3)). Next, for example, in the case where the state of the object changes from a proximity state to a contact state at a timing of a frame F(C+2), at the next detection frame F(C+3), a detection point 3B of a contact object is obtained. More specifically, point information including a determination result that a contact object is present is obtained, and the control section 21 changes from the drive interval MC to the drive interval MH based on such point information. Therefore, switching from the proximity point detection mode to the contact point detection mode is performed.

D. Switching from Proximity Point Detection Mode to Detection Standby Mode

As illustrated in FIG. 8B, in the proximity point detection mode, first, at a timing of a frame F(D+1), a detection point 3A of a proximity object is obtained. Therefore, as in the case of the above-described frames F(C+1) to F(C+3), the control section 21 maintains the drive interval MC (from the frame F(D+1) to a frame F(D+3)). Next, in the case where the object is neither in the proximity state nor the contact state from a timing of a frame F(D+2), at the next detection frame F(D+3), point information including a determination result that a contact object and a proximity object are absent is obtained. The control section 21 changes from the drive interval MC to the drive interval ML based on such point information. Therefore, switching from the proximity point detection mode to the detection standby mode is performed.

Thus, in the proximity point detection mode, when it is determined that a proximity object is present (and a contact object is absent), the control section 21 still maintains the drive interval MC. On the other hand, when it is determined that a contact object is present, the control section 21 performs control to change from the drive interval MC to the drive interval MH, and when it is determined that a contact object and a proximity object are absent, the control section 21 performs control to change from the drive interval MC to the drive interval ML.

E. Switching from Contact Point Detection Mode to Proximity Point Detection Mode

As illustrated in FIG. 9A, in the contact point detection mode, at each of timings of frames F(E+0) to F(E+2), the above-described image processing (the point information detection process) is performed. At each of the timings, a detection point 3B of a contact object is obtained, and point information including a determination result that a contact object is present is obtained. The control section 21 maintains the drive interval MH based on such point information (from the frame F(E+0) to a frame F(E+3)). Next, for example, in the case where at the timing of the frame F(E+3), the state of the object changes from the contact state to the proximity state, at the timing of the frame F(E+3), a detection point 3A of a proximity object is obtained. More specifically, point information including a determination result that a proximity object is present is obtained, and the control section 21 changes from the drive interval MH to the drive interval MC based on such point information. Therefore, switching from the contact point detection mode to the proximity point detection mode is performed.

F. Switching from Contact Point Detection Mode to Detection Standby Mode

As illustrated in FIG. 9B, in the contact point detection mode, first, at each of timings of frames F(G+0) to F(G+2), a detection point 3B of a contact object is obtained. Therefore, as in the case of the above-described frames F(E+0) to F(E+2), the control section 21 maintains the drive interval MH (from the frame F(G+0) to a frame F(G+3)). Next, for example, in the case where at a timing of the frame F(G+3), the object in contact with or in proximity to the input screen becomes absent, at the timing of the frame F(G+3), point information including a determination result that a contact object and a proximity object are absent is obtained. The control section 21 changes from the drive interval MH to the drive interval ML based on such point information. Therefore, switching from the contact point detection mode to the detection standby mode is performed.

Thus, in the contact point detection mode, when it is determined that a contact object is present, the control section 21 still maintains the drive interval MH. On the other hand, when it is determined that a proximity object is present (and a contact object is absent), the control section 21 performs control to change from the drive interval MH to the drive interval MC, and when it is determined that both of a contact object and a proximity object are absent, the control section 21 performs control to change from the drive interval MH to the drive interval ML.

In the case where both of touch point information including a determination result that “a contact object is present” and proximity point information including a determination result that “a proximity object is present” are obtained in the above-described steps of obtaining point information, an object is considered to be in the contact state, and switching from the detection standby mode or the proximity point detection mode to the contact point detection mode is performed.

As described above, in the embodiment, point information about the presence or absence of an object in contact with the input screen and an object in proximity to the input screen is obtained based on the picked-up image data D0 of the object, and the drive interval is changed based on such point information. In other words, the drive interval is dynamically changed according to the state of the object so as to perform switching of the detection modes.

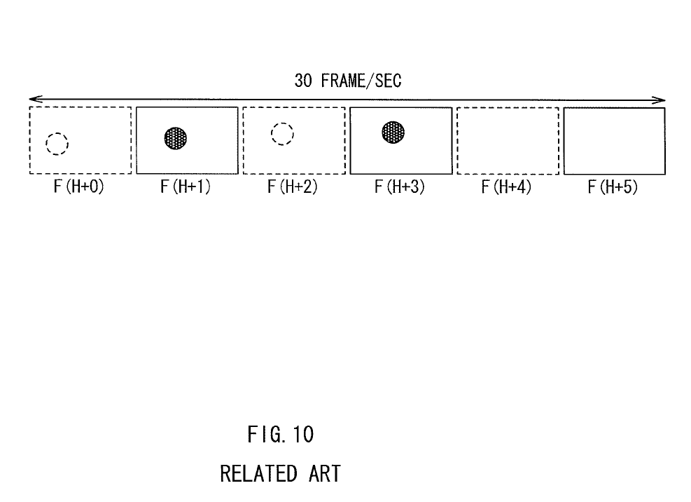

Next, an intermittent photodetection drive operation according to a comparative example will be described below referring to FIG. 10. In the comparative example, the photodetection cell CR is driven at, for example, drive intervals of 30 fps, so compared to the case where the photodetection cell CR is driven at full drive intervals (60 fps), a reduction in power consumption is allowed. Moreover, when the backlight is intermittently driven in synchronization with the drive intervals of the photodetection cell CR, power consumption is largely reduced. However, in such a comparative example, for example, in the case a flick operation is performed from a timing of a frame F(H+0) to a timing of a frame F(H+4), it is difficult to sufficiently recognize temporally continuous movement. In other words, it is difficult to input information by an active operation such as the flick operation. Moreover, the lower the drive interval is, the more such an adverse effect is pronounced.

On the other hand, in the embodiment, in a state where an object is not in contact with the input screen (the detection standby mode and the proximity point detection mode), the drive interval is set to be lower (the drive intervals ML and MC), and therefore power consumption is reduced. Then, in the case where an object in contact with the input screen is detected in the detection standby mode and the proximity point detection mode, the drive interval is dynamically changed to a longer drive interval (the drive interval MH), and switching from the detection standby mode and the proximity point detection mode to the contact point detection mode is performed. Therefore, for example, as illustrated in FIGS. 7A and 8A, a flick operation by a contact object is sufficiently recognizable. Moreover, two threshold values S1 and S2 are used in a binarization process in the image processing section 14 so as to obtain not only touch point information of an object but also proximity point information, so an input operation is allowed not only in the case where an object is in contact with the input screen but also in a non-contact state where the object is placed at a predetermined height from the input screen. Therefore, while the photodetection cell CR is driven intermittently, deterioration of operability is preventable. Therefore, good operability is allowed to be maintained while reducing power consumption.

Modification 1

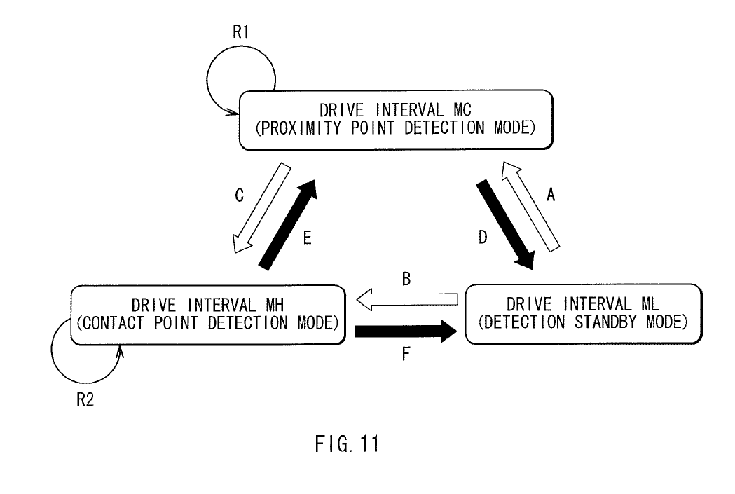

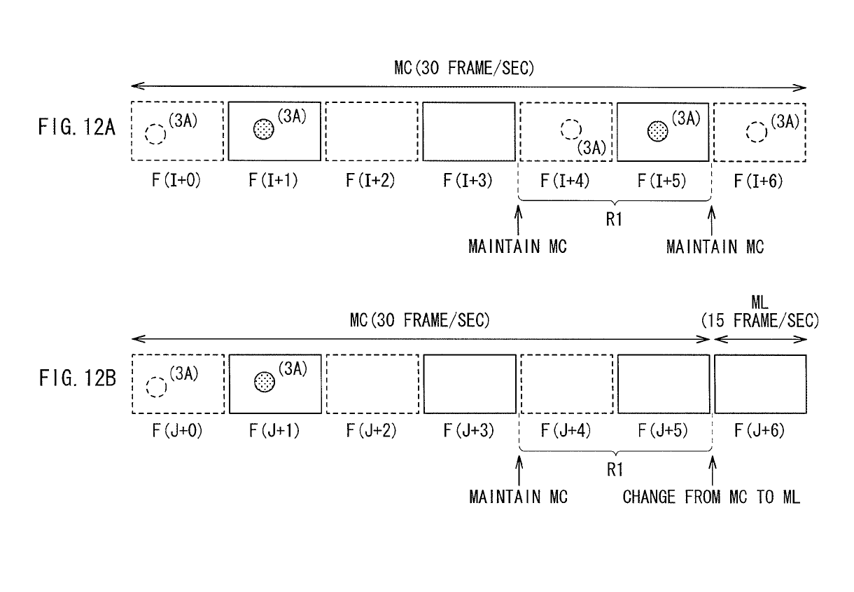

FIG. 11 is an illustration of switching of object detection modes according to Modification 1 of the above-described embodiment. The modification is applied to the display 10 and the electronic device body 20 in the same manner as in the above-described embodiment, except that a timing of switching of object detection modes (a timing of changing the drive interval) is different from that in the embodiment. More specifically, in the modification, as in the case of the embodiment, the object detection modes including the detection standby mode (the drive interval ML), the proximity point detection mode (the drive interval MC) and the contact point detection mode (the drive interval MH) are allowed to be switched from one to another. However, in the modification, when the drive interval is changed to a lower drive interval, the timing of changing the drive interval is controlled to be delayed. More specifically, in each of switching from the proximity point detection mode to the detection standby mode (D), switching from the contact point detection mode to the proximity point detection mode (E) and switching from the contact point detection mode to the detection standby mode (F), the timing of changing the drive interval is controlled to be delayed by a predetermined time R1 or R2. Examples of the timing of switching of these modes will be described below referring to FIGS. 12A and 12B to FIGS. 14A and 14B.

D. Switching from Proximity Point Detection Mode to Detection Standby Mode

FIGS. 12A and 12B are schematic views, in the proximity point detection mode, in the case where when a determination result that both of a contact object and a proximity object are absent is obtained, the timing of changing the drive interval is delayed by the predetermined time R1. Thus, even in the case where the determination result that both of a contact object and a proximity object are absent is obtained at frame F(I+3) or F(J+3), the drive interval MC is maintained for the time R1. The time R1 may be set to, for example, a few frames (in this case, 2 frames).

When a change from the drive interval MC to the drive interval ML is delayed by the time R1 in such a manner, for example, as illustrated in FIG. 12A, also in the case where a proximity object appears again from the next detection frame F(I+4), the proximity object is easily detected without fail (a frame F(I+5)). Note that thereafter, the drive interval MC is maintained (from a frame F(I+6) or later). Such an effect is specifically effective to recognize an input operation accompanied by movement, in which an object quickly touches or moves away from the input screen, such as a double click. On the other hand, as illustrated in FIG. 12B, in the case where both of a contact object and a proximity object do not appear (a frame F(J+5)) after the lapse of the time R1, the drive interval MC may be changed to the drive interval ML.

E. Switching from Contact Point Detection Mode to Proximity Point Detection Mode

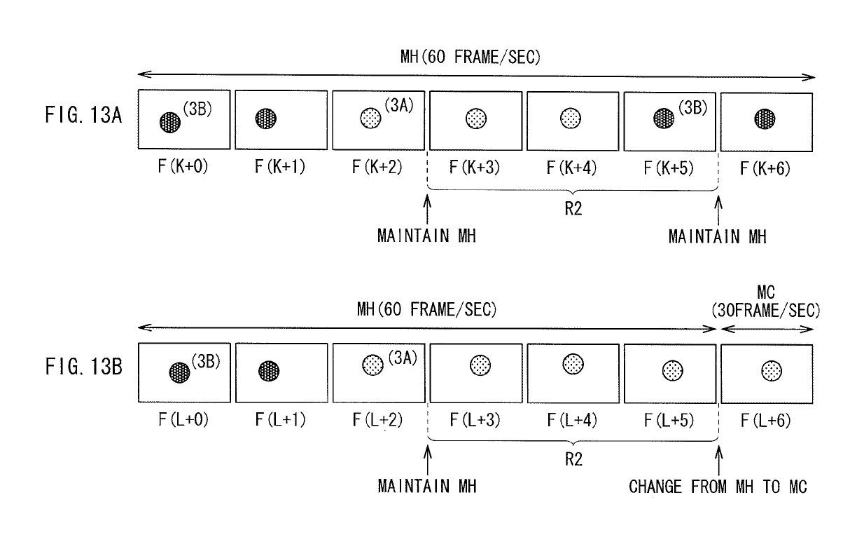

FIGS. 13A and 13B are schematic views in the case where the timing of changing the drive interval is delayed by the predetermined time R2 when the state of an object changes from the contact state to the proximity state in the contact point detection mode. Thus, even in the case where a determination result that a proximity object is present (and a contact object is absent) is obtained in frame F(K+2) or F(L+2), the drive interval MH is maintained for the time R2. The time R2 may be set to, for example, a few frames (in this case, 3 frames).

When a change from the drive interval MH to the drive interval MC is delayed by the time R2, for example, as illustrated in FIG. 13A, also in the case where a contact object appears again from the next detection frame F(K+5), the contact object is easily detected without fail (a frame F(K+5)). Note that thereafter, the drive interval MH is maintained (from a frame F(K+6) or later). Such an effect is specifically effective to recognize an input operation such as a double click. On the other hand, as illustrated in FIG. 13B, in the case where a proximity object is present and a contact object is absent after the lapse of the time R2 (a frame F(L+5)), the drive interval MH may be changed to the drive interval MC.

F. Switching from Contact Point Detection Mode to Detection Standby Mode

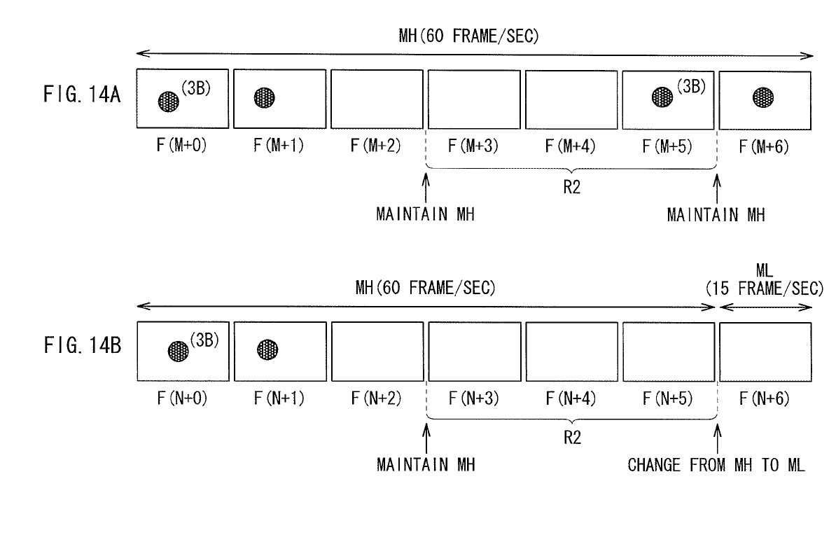

FIGS. 14A and 14B are schematic views in the case where when a determination result that both of a contact object and a proximity object are absent is obtained, a timing of changing the drive interval is delayed by the time R2. Thus, even in the case where a determination result that both of a contact object and a proximity object are absent is obtained in frame F(M+2) or F(N+2), the drive interval MH is maintained for the time R2.

When a change from the drive interval MH to the drive interval ML is delayed by the time R2 in such a manner, for example, as illustrated in FIG. 14A, also in the case where a contact object appears again from the next detection frame F(M+5), the contact object is easily detected without fail (the frame F(M+5)). Note that thereafter, the drive interval MH is maintained (from a frame F(M+6) or later). Such an effect is specifically effective to recognize an input operation such as a double click. On the other hand, as illustrated in FIG. 14B, in the case where both of a contact object and a proximity object do not appear after the lapse of the time R2 (a frame F(N+5)), the drive interval MH may be changed to the drive interval ML.

As described above, in the modification, in the case where the drive interval is changed to a lower drive interval based on the presence or absence of an object in contact with the input screen and an object in proximity to the input screen, the timing of changing the drive interval is controlled to be delayed, and therefore, for example, an input operation such as a double click is well recognizable. Therefore, good operability is allowed to be maintained while reducing power consumption.

Modification 2

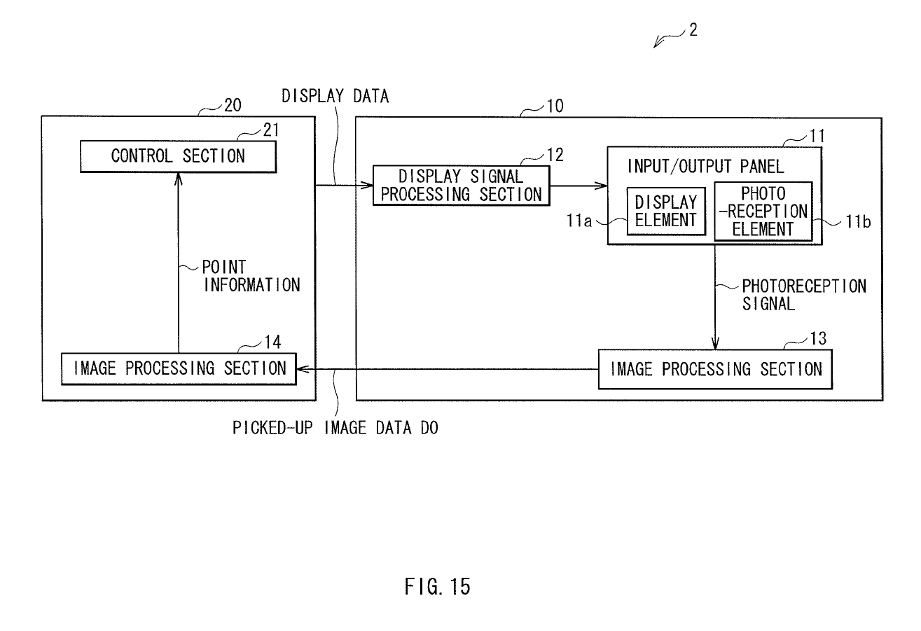

FIG. 15 illustrates a block configuration of an information input/output device 2 according to Modification 2. As in the case of the information input/output device 1 according to the above-described embodiment, the information input/output device 2 includes the display 10 and the electronic device body 20, but the display 10 includes the display signal processing section 12, the input/output panel 11 and the photodetection signal processing section 13. The electronic device body 20 includes the control section 21 and the image processing section 14. In other words, in the modification, the image processing section 14 is included in not the display 10 but the electronic device body 20. The image processing section 14 may be included in the electronic device body 20 in such a manner, and even in such a case, the same effects as those in the information input/output device 1 according to the above-described embodiment are obtainable.

### APPLICATION EXAMPLES

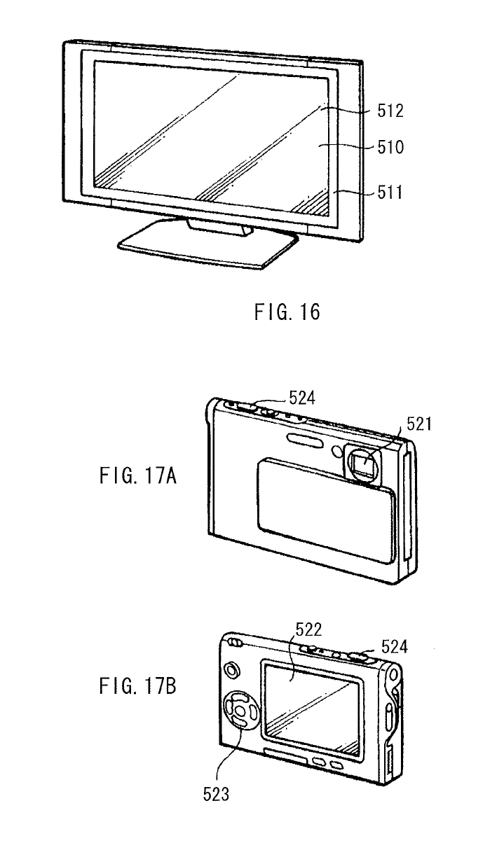

Next, referring to FIG. 16 to FIGS. 20A to 20G, application examples of the information input/output devices described in the above-described embodiment and above-described modifications will be described below. The information input/output devices according to the above-described embodiment and the like are applicable to electronic devices in any fields such as televisions, digital cameras, notebook personal computers, portable terminal devices such as cellular phones, and video cameras. In other words, the information input/output devices according to the above-described embodiment and the like are applicable to electronic devices displaying a picture signal input from outside or a picture signal generated inside as an image or a picture in any fields.

### Application Example 1

FIG. 16 illustrates an appearance of a television. The television has, for example, a picture display screen section 510 including a front panel 511 and a filter glass 512. The picture display screen section 510 is configured of the information input/output device according to any of the above-described embodiment and the like.

### Application Example 2

FIGS. 17A and 17B illustrate appearances of a digital camera. The digital camera has, for example, a light-emitting section 521 for a flash, a display section 522, a menu switch 523, and a shutter button 524. The display section 522 is configured of the information input/output device according to any of the above-described embodiment and the like.

### Application Example 3

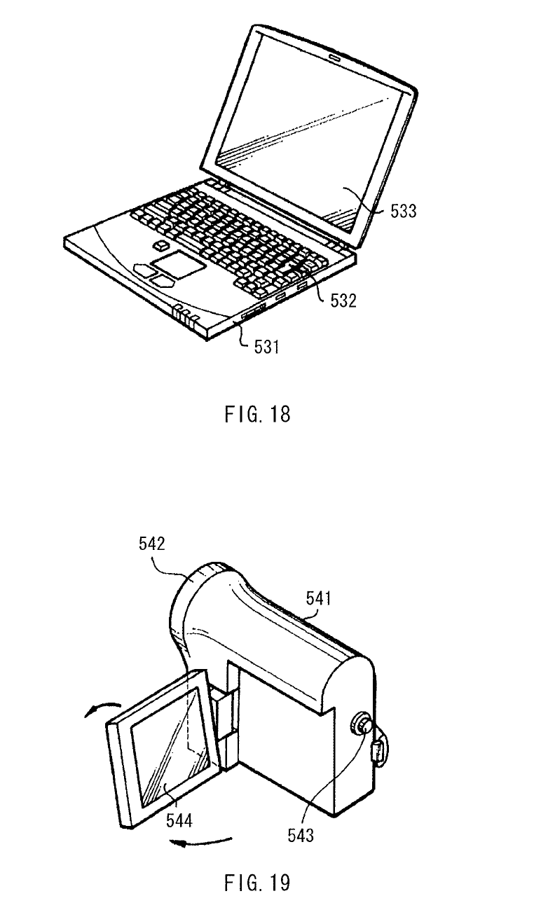

FIG. 18 illustrates an appearance of a notebook personal computer. The notebook personal computer has, for example, a main body 531, a keyboard 532 for operation of inputting characters and the like, and a display section 533 for displaying an image. The display section 533 is configured of the information input/output device according to any of the above-described embodiment and the like.

### Application Example 4

FIG. 19 illustrates an appearance of a video camera. The video camera has, for example, a main body 541, a lens 542 for shooting an object arranged on a front surface of the main body 541, a shooting start/stop switch 543, and a display section 544. The display section 544 is configured of the information input/output device according to any of the above-described embodiment and the like.

### Application Example 5

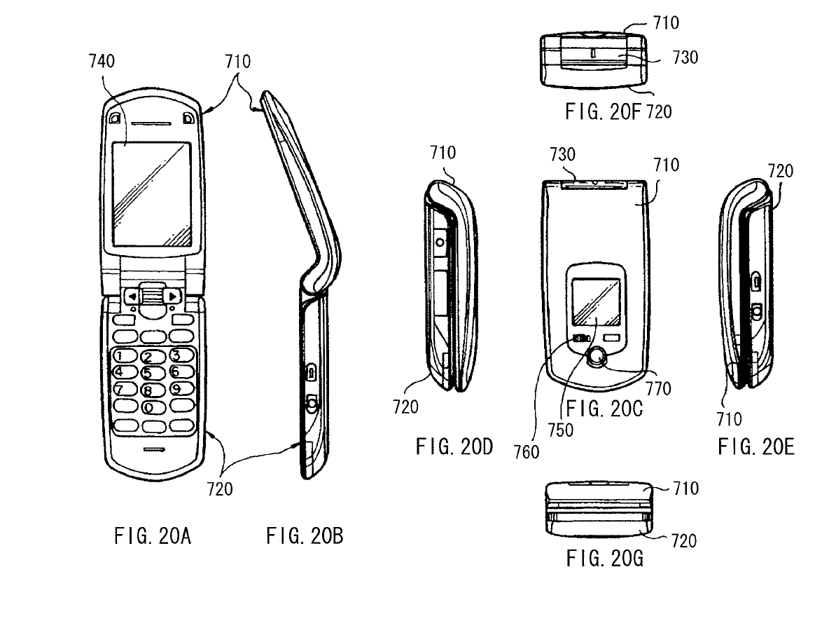

FIGS. 20A to 20G illustrate appearances of a cellular phone. The cellular phone is formed by connecting, for example, a top-side enclosure 710 and a bottom-side enclosure 720 to each other by a connection section (hinge section) 730. The cellular phone has a display 740, a sub-display 750, a picture light 760, and a camera 770. The display 740 or the sub-display 750 is configured of the information input/output device according to any of the above-described embodiment and the like.

Although the present invention is described referring to the embodiment, the modifications, and the application examples, the invention is not limited thereto, and may be variously modified. For example, in the above-described embodiment and the like, as an object detection system, an optical system in which detection is performed with use of reflected light from an object by the photodetectors 11b arranged in the input/output panel 11 is described as an example, but any other detection system such as a contact system or a capacitive system may be used. In any of detection systems, a drive interval may be set so as to obtain a detection signal at intermittent timings, and the drive interval may be changed according to the presence or absence of an object in contact with or in proximity to the input screen.

Moreover, in the above-described embodiment and the like, three modes, that is, the detection standby mode, the proximity point detection mode and the contact point detection mode are described as examples of the object detection modes, but the invention is not necessarily limited to these three modes. For example, the proximity point detection mode may be further divided into a plurality of modes to use 4 or more object detection modes. In other words, a plurality of drive intervals changing in multiple stages may be used as drive intervals in the proximity point detection mode to detect the proximity state of an object (such as the height of an object from the input screen), and the drive interval may be chanted according to such a state.

Further, in the above-described embodiment and the like, the case where a full drive interval (60 fps) is used as the drive interval in the contact point detection mode is described as an example, but the invention is not limited thereto, and a drive interval of 60 fps or over, for example, 120 fps may be used. Moreover, the drive intervals in the detection standby mode and the proximity point detection mode are not limited to 15 fps and 30 fps, respectively, which are described in the above-described embodiment and the like. For example, the drive interval in the proximity point detection mode may be set to be equal to the drive interval in the contact point detection mode.

In addition, in the above-described embodiment and the like, the case where the control section 21 is arranged in the electronic device body 20 is described, but the control section 21 may be arranged in the display 10.

Moreover, in the above-described embodiment and the like, the information input/output device with an input/output panel having both of a display function and a detection function (a photodetection function) is described as an example, but the invention is not limited thereto. For example, the invention is applicable to an information input/output device configured of a display with an external touch sensor.

Further, in the above-described embodiment and the like, the case where the liquid crystal display panel is used as the input/output panel is described as an example, but the invention is not limited thereto, and an organic electroluminescence (EL) panel or the like may be used as the input/output panel. In the case where the organic EL panel is used as the input/output panel, for example, a plurality of organic EL elements may be arranged on a substrate as display elements, and one photodiode as a photodetector may be arranged so as to be allocated to each of the organic EL elements or two or more organic EL elements. Moreover, the organic EL element has characteristics of, when a forward bias voltage is applied, emitting light, and, when a backward bias voltage is applied, receiving light to generate a current. Therefore, when such characteristics of the organic EL element are used, even if the photodetector such as a photodiode is not arranged separately, an input/output panel having both of the display function and the detection function is achievable.

In addition, in the above-described embodiment and the like, the invention is described referring to the information input/output device with the input/output panel having a display function and a detection function (a display element and a photodetector) as an example, but the invention does not necessarily have a display function (a display element). In other words, the invention is applicable to an information input device (an image pickup device) with an input panel having only a detection function (a photodetector). Further, such an input panel and an output panel (a display panel) having a display function may be arranged separately.

The processes described in the above-described embodiment and the like may be performed by hardware or software. In the case where the processes are performed by software, a program forming the software is installed in a general-purpose computer or the like. Such a program may be stored in a recording medium mounted in the computer in advance.

The present application contains subject matter related to that disclosed in Japanese Priority Patent Application JP 2009-239512 filed in the Japan Patent Office on Oct. 16, 2009, the entire content of which is hereby incorporated by references.

It should be understood by those skilled in the art that various modifications, combinations, sub-combinations and alterations may occur depending on design requirements and other factors insofar as they are within the scope of the appended claims or the equivalents thereof.

What is claimed is:

1. An information input device comprising:
an input panel including detection elements each obtaining a detection signal from an object;
an image processing section performing predetermined image processing on the detection signal obtained by the input panel, thereby obtaining touch point information which is indicative of whether the object is in a touch state and proximity point information which is indicative of whether the object is in a proximity state;
a drive section driving each of the detection elements in the input panel in such a manner that the detection signal is obtained from each of the detection elements at predetermined drive intervals; and
a control section determining the drive interval based on the touch point information and the proximity point information obtained by the image processing section.

2. The information input device according to claim 1, wherein
the image processing section detects the touch point information through a comparison process on the detection signal with use of a first threshold value, and obtains the proximity point information through a comparison process on the detection signal with use of a second threshold value which is lower than the first threshold value.

3. The information input device according to claim 2, wherein
the control section employs a first drive interval as the drive interval when in a detection standby mode where the object is neither in the touch state nor in the proximity state, a second drive interval as the drive interval when in a proximity point detection mode where the object is in the proximity state, and a third drive interval as the drive interval when in a touch point detection mode where the object is in the touch state, the second drive interval being equal to or longer than the first drive interval, the third drive interval being equal to or longer than the second drive interval.

4. The information input device according to claim 3, wherein
the control section stays in the detection standby mode through maintaining the first drive interval, when the control section determines that the object is neither in the touch state nor in the proximity state,
the control section transitions from the detection standby mode to the proximity point detection mode through switching from the first drive interval to the second drive interval, when the control section determines that the object is in the proximity state, and
the control section transitions from the detection standby mode to the touch point detection mode through switching from the first drive interval to the third drive interval, when the control section determines that the object is in the touch state,

5. The information input device according to claim 3, wherein
the control section stays in the proximity point detection mode through maintaining the second drive interval, when the control section determines that the object is in the proximity state,
the control section transitions from the proximity point detection mode to the touch point detection mode through switching from the second drive interval to the third drive interval, when the control section determines that the object is in the contact state, and
the control section transitions from the proximity point detection mode to the detection standby mode through switching from the second drive interval to the first drive interval, when the control section determines that the object is neither in the touch state nor the proximity state.

6. The information input device according to claim 5, wherein
a timing of switching from the second drive interval to the first drive interval is delayed, in the transition from the proximity point detection mode to the detection standby mode.

7. The information input device according to claim 3, wherein
the control section stays in the contact point detection mode through maintaining the third drive interval, when the control section determines that the object is in the contact state,
the control section transitions from the contact point detection mode to the proximity point detection mode through switching from the third drive interval to the second drive interval, when the control section determines that the object is in the proximity state, and
the control section transitions from the touch point detection mode to the detection standby mode through switching from the third drive interval to the first drive interval, when the control section determines that the object is neither in the touch state nor in the proximity state.

8. The information input device according to claim 7, wherein
a timing of switching from the third drive interval to the first drive interval is delayed, in the transition from the touch point detection mode to the detection standby mode, and
a timing of switching from the third drive interval to the second drive interval is delayed, in the transition from the touch point detection mode to the proximity point detection mode.

9. The information input device according to claim 1, wherein
the detection elements are configured of a plurality of photodetectors which detect light reflected by an object.

10. An information input method comprising steps of:
obtaining a detection signal from an object by an input panel including detection elements;
performing predetermined image processing on the obtained detection signal, thereby obtaining touch point information which is indicative of whether the object is in a touch state and proximity point information which is indicative of whether the object is in a proximity state;
driving each of the detection elements in the input panel in such a manner that the detection signal is obtained from each of the detection elements at predetermined drive intervals; and
determining the drive interval based on the touch point information and the proximity point information.

11. An information input/output device comprising:
an input/output panel including detection elements each obtaining a detection signal from an object and having an image display function;
an image processing section performing predetermined image processing on the detection signal obtained by the input/output panel, thereby obtaining touch point information which is indicative of whether the object is in a touch state and proximity point information which is indicative of whether the object is in a proximity state;
a drive section driving each of the detection elements in the input/output panel in such a manner that the detection signal is obtained from each of the detection elements at predetermined drive intervals; and
a control section determining the drive interval based on the touch point information and the proximity point information obtained by the image processing section.

12. The information input/output device according to claim 11, wherein
the input/output panel includes a plurality of display elements displaying an image based on image data, and
the detection elements are configured of a plurality of photodetectors which detect light reflected by an object.

13. A computer readable non-transitory medium on which an information input program is recorded, the information input program allowing a computer to execute steps of:
obtaining a detection signal from an object by an input panel including detection elements;
performing predetermined image processing on the obtained detection signal, thereby obtaining touch point information which is indicative of whether the object is in a touch state and proximity point information which is indicative of whether the object is in a proximity state;
driving each of the detection elements in the input panel in such a manner that the detection signal is obtained from each of the detection elements at predetermined drive intervals; and
determining the drive interval based on the touch point information and the proximity point information.

14. An electronic unit having an information input device, the information input device comprising:
an input panel including detection elements each obtaining a detection signal from an object;
an image processing section performing predetermined image processing on the detection signal obtained by the input panel, thereby obtaining touch point information which is indicative of whether the object is in a touch state and proximity point information which is indicative of whether the object is in a proximity state;
a drive section driving each of the detection elements in the input panel in such a manner that the detection signal is obtained from each of the detection elements at predetermined drive intervals; and
a control section determining the drive interval based on the touch point information and the proximity point information obtained by the image processing section.
